(19) United States
(12) Patent Application Publication
(10) Pub. No.: US 2011/0111195 A1
(43) Pub. Date: May 12, 2011

(54) METHOD FOR PRODUCING A BASE LAP OF COMPOSITE YARNS COMPRISING AN UNTWISTED COTTON SHEATH, PRODUCT OBTAINED, AND CORRESPONDING INSTALLATION

(76) Inventors: Josep Bernadas Rosello, Barcelona (ES); Joaquin Balasch Risueño, Barcelona (ES)

(21) Appl. No.: 12/936,256

(22) PCT Filed: Oct. 8, 2008
(86) PCT No.: PCT/ES08/00630

§ 371 Date: Jan. 18, 2011

(30) Foreign Application Priority Data
Apr. 4, 2008 (ES) P200800941

(51) Int. Cl. D04H 13/00; B32B 29/02; B29C 47/02; B32B 5/00

(52) U.S. Cl. 428/219; 156/178; 156/393; 442/330

(57) ABSTRACT

The invention relates to the entire method for arranging parallel yarns from a warp on a cotton lap having passed through a card or a combing machine or other textile machine used for the same purpose, forming a composite lap of parallel yarns and a lap of irregularly arranged untwisted cotton fibrils. The end result is a firm lap in which many of the untwisted cotton fibrils are wrapped coaxially around each so-called carrier yarn, forming the corresponding composite yarn, and the remaining fibrils are perpendicular to the composite yarns, providing the resulting lap with a consistency such that it can both be cut to obtain the yarns comprising an untwisted cotton sheath, and also used for any desired purpose.

### OBJECT OF THE INVENTION

The present invention, as this specification states in its title, relates to a method for producing a base lap of composite yarns comprising an untwisted cotton sheath, product obtained, and corresponding installation.

It is intended for producing a highly environment-friendly, resistant, very cheap (only contains cotton, water-soluble glue and has no woven structure) final product with a very low energy cost, applicable to many purposes, coarse appearance of which can be an added value (grocery bags, small single mats and, other multiple applications).

The weight of cotton material (yarn plus cotton fibrils) used for a certain purpose is less than the weight of paper equivalent for the same purpose. This makes the product from the lap along with the yarns of the process of the invention a highly simple, cheap, ecological resource and in harmony with the sustained growth since, by partially substituting the paper, cutting down trees and power consumption are avoid.

The Denier quality of yarns from the warp machine, having been irregularly wrapped with cotton fibrils, increases their quality and modifies their elongation resistance and shear stress to which a certain portion of the lap may be subjected.

The main purpose of the lap obtained through the process of the invention, is the application of a simple cutting operation between adjacent yarns thus obtaining a composite yarn comprising an untwisted cotton sheath, which once coned, may be intended for any weaving operation.

### BACKGROUND OF THE INVENTION

In the application of a single utilization, it is known the use of materials from cellulose without woven structure built by accumulating different layers of this material with mechanical or hydro punching method or, by bonding different layers with chemical products or the like.

On the other hand, documents of the state of the art and documents that are public domain, describe methods for producing a ribbon to which a yarn has been adhered without observing any variation of the Denier quality throughout the process. Producing a flat ribbon greatly complicates the application in subsequent weaving operations.

Furthermore, the fact of not changing the direction of cotton fibres of the lap causes the yarns to lose parallelism and the cutting operation to be extremely difficult and slow.

### DESCRIPTION OF THE INVENTION

The method for producing the base lap of composite yarns comprising an untwisted cotton sheath begins with the feeding of cotton fibrils having passed through a card in order to form a first initial cotton lap.

This first initial cotton lap reaches a confluence collection cylinder into which some parallel yarns, as many as the final product requires and as many as the cotton lap width allows are added, yarns that are integrated into that cotton lap, and which comes from a warp machine.

From the confluence collection cylinder the base lap to be produced in the process already comprises the necessary structural elements (group of parallel yarns and cotton fibrils), thus forming a complete lap.

Then the lap formed by yarns and cotton fibrils is subjected to a pre-gluing phase, being previously pressed by two cylinders in order to remove all the air contained into the tubular structure of cotton fibrils.

In the pre-gluing phase, the structure of cotton fibrils and yarns is slightly dipped into a vat containing water and glue with low viscosity.

This pre-gluing phase is then followed by the pre-drying phase.

In a subsequent phase, a proper gluing is performed, wherein the glue plus water solution contained into the vat may have a higher viscosity, while others hydrosoluble products can be added depending on the final purpose of the product from the process of the invention.

Following the complete gluing phase there is a progressive drying phase from low to high temperature developed through a series of hot cylinders.

This progressive drying phase tries to facilitate the movement of cotton fibrils during the mass attraction process occurring at the exit of the drying phase between the last drying cylinder and a folding cylinder for the final obtained lap.

In this mass attraction process, a part of cotton fibres completely surrounds the carrier yarns increasing the Denier quality and another part of the fibrils takes a direction perpendicular to said yarns and gives consistency to the whole final lap maintaining the exact parallelism between the yarns from the warp machine.

The installation for producing the base lap of the invention has already been indirectly described when describing the method. The product obtained is produced using the described method.

Next, in order to facilitate a better understanding of this specification and being an integral part thereof, some figures in which the object of the invention has been represented with an illustrative and not limitative manner are attached.

### BRIEF DESCRIPTION OF THE DRAWINGS

FIG. 1.—Shows a schematic view of the method for producing the base lap of composite yarns comprising an untwisted cotton sheath, product obtained, and corresponding installation, object of the invention.

FIG. 2.—Shows a plan view of a structure of cotton fibrils constituting an initial lap.

FIG. 3.—Shows the parallel arrangement of a group of yarns into which cotton fibrils are incorporated in one of the initial phases of the method.

FIG. 4.—Shows another plan view of a structure of cotton fibrils comprising the yarns mentioned in the previous figure.

FIG. 5.—Shows another view similar to the previous one wherein the product obtained at the end of the process is shown.

FIG. 6.—Shows a sectional elevation view of that depicted in the previous figure.

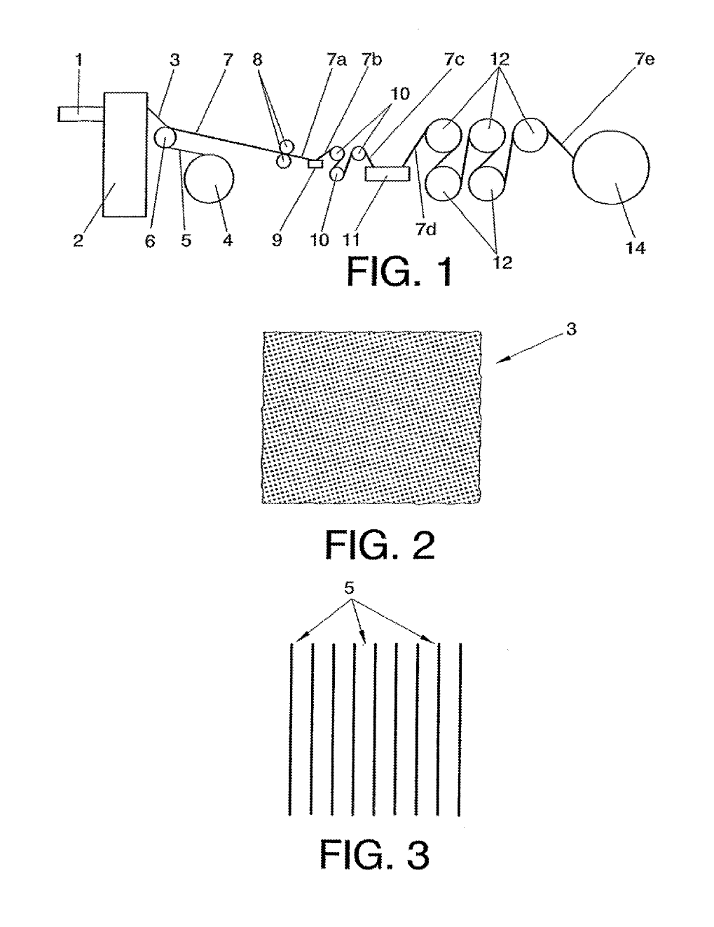

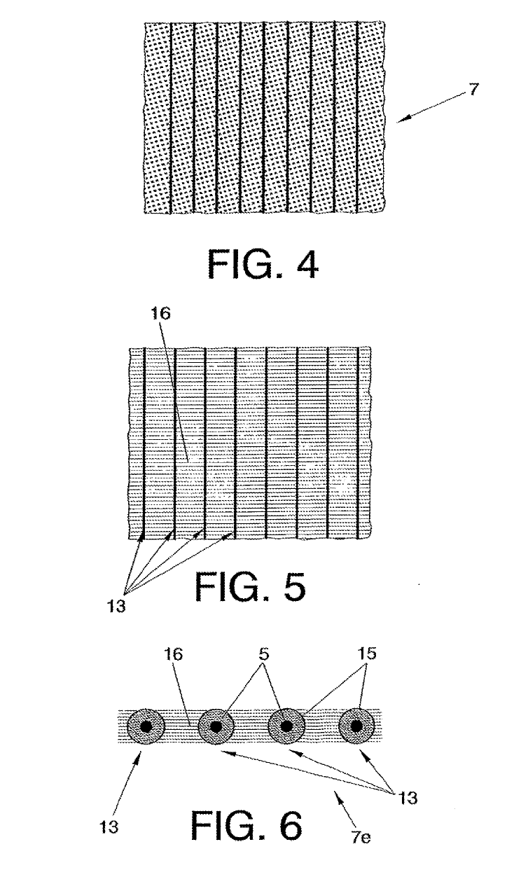

### DESCRIPTION OF THE PREFERRED EMBODIMENT

Considering the numbering adopted in the figures, the method for producing the base lap of composite yarns comprising an untwisted cotton sheath begins with the supply of cotton fibrils 3 through a feeder 1 for said fibrils 3, which then pass to a textile machine (card) 2 in order to form an initial lap of irregularly arranged untwisted cotton fibrils 3 that subsequently reach a confluence collection cylinder 6 for this initial lap 3 and some yarns 5 coming from a warp machine 4 that supplies yarns 5 to the system in a parallel manner, so that through said confluence cylinder 6 the lap of cotton fibrils 3 is combined with the yarns 5, these being integrated into the cotton lap 3, obtaining a composite lap structure 7 at the exit of the confluence collection cylinder 6. The mentioned yarns 5 will remain parallel throughout the process and also of course in the final product obtained.

The initial lap of cotton fibrils has a determined thickness in order to give the yarns the desired Denier quality.

Then, the complete lap structure 7 comes up to a pressing phase using a pair of pressing cylinder 8 in order to remove, as far as possible, the air contained into the tubular structure of cotton fibrils.

In another subsequently phase, the pressed complete lap structure 7a is subjected to a pre-gluing by slightly dipping it into an anterior vat 9, content of which is a low viscosity water and glue mixture prepared for a slight and light dipping. This pre-gluing phase can be repeated several times depending on the type of source or length of cotton fibres. Then a pre-drying phase has been provided through lower drying cylinders 10.

The following phase is the proper gluing using glue plus water solution contained in a posterior vat 11, solution that can have a higher viscosity than the previous one and wherein other hydrosoluble products can be added depending on the purpose of the final product obtained with the process of the invention.

Subsequently, there is a drying phase at progressive temperature using drying cylinders 12 so as the cotton fibres take the required direction. Thus, a percentage of fibres completely surround each yarn 5 coming from the lap in order to obtain the desired Denier quality, while the rest of the fibres will be directed in a direction perpendicular to the yarns 5 causing the obtained lap 7e to have its own consistency.

Then the drying phase through drying cylinders 12 results in a final product 7e, wherein composite yarns 13 having taken the desired Denier quality are obtained, and remaining fibres 16 having taken a perpendicular direction ensure the attachment and immobilization of the composite yarns 13.

The final product obtained 7e will be wound around a folding cylinder 14.

On the other hand, each composite yarn 13 includes the carrier yarn 5 provided by the warp machine 4 and a coaxial sheath 15 generated in the process of the invention.

FIG. 6 shows clearly a section of the final product obtained.

In a particular example, a warp machine is provided with 90 parallel yarns of 300/1 Denier quality and a composite yarn of 600/1 Denier is desired to be produced by cutting the lap obtained in the process of the invention.

Over the 90 parallel yarns from the warp machine a lap of cotton fibres weight of which should be: 300/075=400 grams per each 100 meters of the 90 warp yarns will have to be applied.

Once processed in the system the whole 90 yarns with 400 grams of cotton fibre a lap will be obtained, weight of which per square meter will be: (300+400)/100 plus the weight of added solids (glue plus other elements), i.e. about 8 grams per square meter.

Once at this point, it is decided whether the lap will be directly used for sale or a simple cutting operation have to be applied in order to convert the result in 90 composite yarns comprising an untwisted cotton sheath.

The installation for producing the desired product is clearly obtained from that previously described although it will be described in more detail below.

Therefore, the installation comprises:
Feeder 1 for cotton fibrils.
Textile machine 2 for receiving cotton fibrils and, which is capable of supplying the initial lap of cotton fibrils 3.
Confluence collection cylinder 6 for simultaneously receiving the initial lap of cotton fibrils 3 and the group of parallel yarns 5 as well supplied by the warping 4 which are integrated into the lap in order to obtain the composite lap 7.
Two pressing cylinders 8 for the composite lap 7 in order to remove as far as possible the air contained into the tubular structure of cotton fibres.
First water and glue mixture contained into the anterior vat 9 and prepared for a light dipping and gluing of the composite and pressed lap 7a.
Lower drying cylinders 10 for the composite, pressed, and dipped lap 7b.
Second glue and water mixture contained into the posterior vat 11 for carrying out a more intense final gluing of the lap.
Drying cylinders 12 at progressive temperature, from low to high temperature, such drying cylinders 12 being located after the posterior vat 11.
Folding device 14 of the final lap obtained 7e.

1-12. (canceled)

13. A method for producing a base lap of composite yarns comprising an untwisted cotton sheath, the method being intended for producing an environment-friendly base lap with high resistance and low cost, wherein it comprises:
a first phase where a textile machine (2) receives cotton fibrils for subsequently supplying an initial cotton lap (3);
a second phase where a confluence collection cylinder (6) receives the initial cotton lap (3) and a group of parallel yarns (5) as well, which are integrated into the initial cotton lap (3) thus obtaining a composite lap (7);
a third phase where the composite lap (7), cotton fibrils and yarn, obtained by the collecting cylinder (6) reaches a pressing system in order to remove as much as possible the air contained into the tubular structure of cotton fibrils;
a fourth phase where the composite and pressed lap (7a) is subjected to a slight pre-gluing in a low viscosity glue and water mixture, obtaining a pre-glued lap (7b);
a fifth phase where the resulting lap (7b) of the previous phase is subjected to a pre-drying process, obtaining a pre-dried lap (7c);
a sixth phase of proper gluing more intense than that of the fourth phase, resulting in a glued lap (7d);
a seventh phase of drying at a progressive temperature, from low to high temperature, in order to direct the cotton fibres in perpendicular directions: a first percentage thereof coaxially surrounding the yarns (5) while the rest of the fibres are perpendicularly directed to said yarns (5) and first percentage of cotton fibres, thus obtaining a lap (7e) as final product obtained.

14. The method of claim 13, wherein the lap gluing is performed by dipping into the water and glue mixtures.

15. A product obtained through the method for producing a base lap of composite yarns comprising an untwisted cotton sheath, comprising an environment-friendly base lap with high resistance and low cost, wherein it comprises a structure of cotton fibrils (16) in parallel directions and a perpendicular structure of composite yarns (13) formed by carrier yarns (5), being each carrier yarn (5) surrounded by a coaxial cotton fibrils sheath (15).

16. The product of claim 15, wherein each composite yarn (13) comprises a quality defined between 500/1 and 700/1 Denier.

17. The product of claim 16, wherein it comprises a quality of about 600/1 Denier.

18. The product of claim 15, wherein it comprises a weight between 6 and 10 grs/m².

19. The product of claim 16, wherein it comprises a weight between 6 and 10 grs/m².

20. The product of claim 17, wherein it comprises a weight between 6 and 10 grs/m².

21. The product of claim 18, wherein it comprises a weight of about 8 grs/m².

22. The product of claim 19, wherein it comprises a weight of about 8 grs/m².

23. The product of claim 20, wherein it comprises a weight of about 8 grs/m².

24. An installation for producing a base lap of composite yarns comprising an untwisted cotton sheath, being intended for producing an environment-friendly base lap with high resistance and low cost, wherein it comprises:
a feeder (1) for cotton fibrils;
a textile machine (card) (2) for receiving cotton fibrils and, which is capable of supplying an initial lap of cotton fibrils (3);
a confluence collection cylinder (6) for simultaneously receiving the initial lap of cotton fibrils (3) and a group of parallel yarns (5) as well supplied by a warping (4), which is integrated into the lap in order to obtain a composite lap (7);
a pressing device for the composite lap (7) in order to remove as far as possible the air contained into the tubular structure of cotton fibres;
a first glue and water mixture prepared for a light dipping and slight gluing of the composite and pressed lap (7a);
a pre-drying device for the composite, pressed, and dipped lap (7b);
a second glue and water mixture for carrying out a more intense final gluing of the lap;
a drying device at progressive temperature, from low to high temperature;
a folding device (14) for the final lap obtained (7e).

25. The installation of claim 24, wherein pressing device for the lap (7) comprises a pair of cylinders (8) tangentially pressing during their rotation opposing to the mentioned lap (7) while it moves forward.

26. The installation of claim 24, wherein the first drying device after the first pre-gluing, said first drying device comprising a pair of lower hot cylinders (10) wherein the lap (7b) is put into contact during its forward motion by simultaneously rotating of said lower cylinders (10).

27. The installation of claim 25, wherein the first drying device after the first pre-gluing, said first drying device comprising a pair of lower hot cylinders (10) wherein the lap (7b) is put into contact during its forward motion by simultaneously rotating of said lower cylinders (10).

28. The installation of claim 24, wherein the drying device after the final gluing comprises higher hot cylinders (12) wherein the lap (7b) is put into contact during its forward motion by simultaneously rotating of said higher cylinders (12).

29. The installation of claim 25, wherein the drying device after the final gluing comprises higher hot cylinders (12) wherein the lap (7b) is put into contact during its forward motion by simultaneously rotating of said higher cylinders (12).

30. The installation of claim 26, wherein the drying device after the final gluing comprises higher hot cylinders (12) wherein the lap (7b) is put into contact during its forward motion by simultaneously rotating of said higher cylinders (12).

31. The installation of claim 27, wherein the drying device after the final gluing comprises higher hot cylinders (12) wherein the lap (7b) is put into contact during its forward motion by simultaneously rotating of said higher cylinders (12).

32. The installation of claim 24, wherein the glue and water mixtures are contained into top opened vats (9, 11).

33. The installation of claim 25, wherein the glue and water mixtures are contained into top opened vats (9, 11).

34. The installation of claim 26, wherein the glue and water mixtures are contained into top opened vats (9, 11).

35. The installation of claim 27, wherein the glue and water mixtures are contained into top opened vats (9, 11).

36. The installation of claim 28, wherein the glue and water mixtures are contained into top opened vats (9, 11).

37. The installation of claim 29, wherein the glue and water mixtures are contained into top opened vats (9, 11).

38. The installation of claim 30, wherein the glue and water mixtures are contained into top opened vats (9, 11).

39. The installation of claim 31, wherein the glue and water mixtures are contained into top opened vats (9, 11).
